(19) United States
(12) Patent Application Publication
(10) Pub. No.: US 2024/0184319 A1
(43) Pub. Date: Jun. 6, 2024

(54) Temperature Gradient Control for Internal Regulated Supply

(71) Applicants: Muhammad Yousuf Siddiqui, San Mateo, CA (US); Maneesha Yellepeddi, Los Gatos, CA (US)

(72) Inventors: Muhammad Yousuf Siddiqui, San Mateo, CA (US); Maneesha Yellepeddi, Los Gatos, CA (US)

(21) Appl. No.: 18/398,760

(22) Filed: Dec. 28, 2023

(51) Int. Cl. G05F 1/56

(52) U.S. Cl. CPC G05F 1/56

(57) ABSTRACT

Integrated circuits of the present disclosure may include a temperature dependent voltage source, a divider circuit, an adder circuit, and a voltage regulator. The divider circuit may apply a gradient tuning parameter to a first voltage provided by the temperature dependent voltage source to provide a second voltage to the adder circuit. The adder circuit may apply a level shift voltage to the second voltage to provide a third voltage to the voltage regulator. The voltage level may provide a fourth voltage to digital circuitry of an integrated circuit based on the third voltage.

### BACKGROUND

The present disclosure relates generally to power management circuits, and more specifically to temperature gradient control for internal voltage regulation.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

An integrated circuit such as a field programmable gate array (FPGA) may include some digital circuitry that operates using an internally regulated voltage (V_{CCHG}) that may be an elevated voltage relative to a digital supply voltage (V_{CCL}) used by other digital circuitry of the integrated circuit. V_{CCHG} may be generated using a temperature dependent voltage source. As such, V_{CCHG} may vary as function of temperature. A temperature gradient of V_{CCHG} may limit a usable temperature range of the integrated circuit.

### BRIEF DESCRIPTION OF THE DRAWINGS

Various aspects of this disclosure may be better understood upon reading the following detailed description and upon reference to the drawings in which:

FIG. 1 is a block diagram of an integrated circuit, in accordance with aspects of the present disclosure;

FIG. 2 is a diagram of an example waveform showing voltage as a function of temperature, in accordance with aspects of the present disclosure;

FIG. 3 is a diagram of example waveforms showing voltage as a function of temperature, in accordance with aspects of the present disclosure;

FIG. 4 is a diagram of example waveforms showing voltage as a function of temperature, in accordance with aspects of the present disclosure;

FIG. 5 is a schematic diagram of an example implementation of the power management circuitry of FIG. 1, in accordance with aspects of the present disclosure;

FIGS. 6A-6C are schematic diagrams of example implementations of the digital circuitry of FIG. 1, in accordance with aspects of the present disclosure; and

FIG. 7 is a diagram of example waveforms showing voltage as a function of temperature, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As described above, a temperature gradient of an internally regulated voltage (V_{CCHG}) may limit a usable temperature range of an integrated circuit. For example, gate breakdown voltages in the integrated circuit may vary as a function of temperature. Gate oxide (GOX) reliability criteria such as defects per million (DPM) may define an operating voltage range for regulating V_{CCHG} as temperature fluctuates. Reliability of the integrated circuit may degrade when V_{CCHG} breaches an upper bound voltage or lower bound voltage of the defined operating voltage range defined by the GOX reliability criteria. V_{CCHG} may have a non-zero temperature gradient due to intrinsic properties of one or more devices (e.g., a bipolar junction transistor) forming a temperature dependent voltage source that generates V_{CCHG}. The non-zero temperature gradient may have a magnitude that causes V_{CCHG} to breach an upper bound voltage and/or lower bound voltage of the operating voltage range defined by the GOX reliability criteria before a full temperature range.

Reliability of the integrated circuit may be improved by changing the intrinsic properties of the one or more devices that form the temperature dependent voltage. For example, changing the intrinsic properties of such devices may reduce the magnitude of the non-zero temperature gradient to a desired magnitude that maintains V_{CCHG} within the defined operating voltage range. However, changing the intrinsic properties of the one or more devices that form the temperature dependent voltage may involve modifying a processing node technology used to fabricate the integrated circuit, which may be cost prohibitive. Reliability of the integrated circuit may also be improved by clipping V_{CCHG} to remain within the defined operating voltage range as temperature fluctuates. However, clipping V_{CCHG} may limit performance of the integrated circuit. For example, clipping V_{CCHG} may limit gate overdrive voltage for overdriving pass transistors of the integrated circuit at lower temperatures.

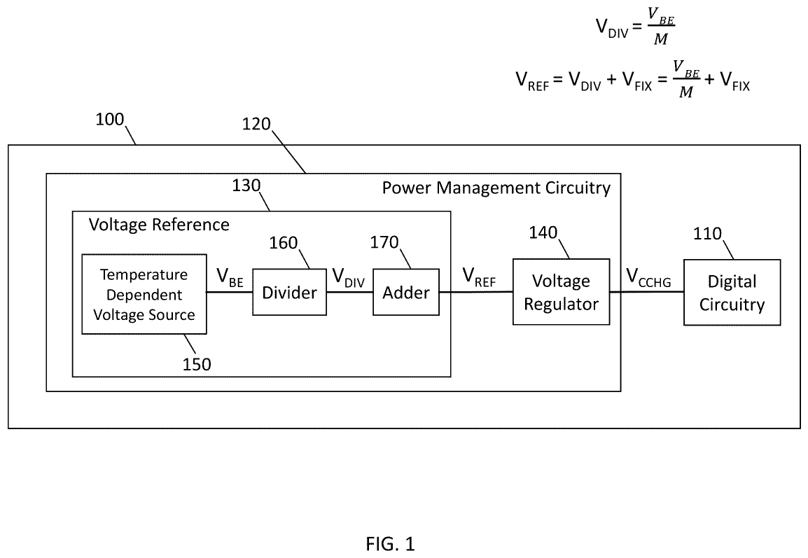

With the foregoing in mind, FIG. 1 is a schematic diagram of an integrated circuit 100, in accordance with aspects of the present disclosure. In an embodiment, the integrated circuit 100 may be a programmable logic device (PLD), such as a field-programmable gate array (FPGA) or an application specific integrated circuit (ASIC). The integrated circuit 100 may include, among other things, digital circuitry 110 that may form, at least, a portion of a digital core of the integrated circuit 100. For example, the digital circuitry 110 may form programmable logic elements and/or programmable routing fabric of the integrated circuit 110 that may be configured to implement various functionalities and/or connections within the integrated circuit 100.

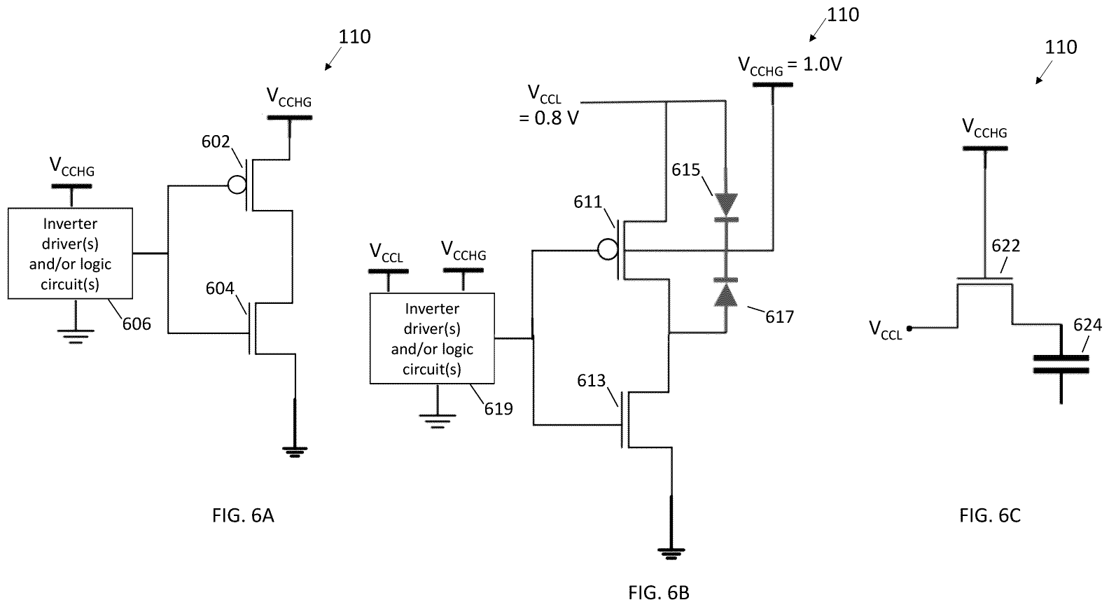

The integrated circuit 100 may also include power management circuitry 120 coupled to the digital circuitry 110. The power management circuitry 120 may be configured to provide V_{CCHG} to the digital circuitry 110. The integrated circuit 100 may have multiple power domains with different voltage levels. For example, the integrated circuit 100 may include a first power domain with a first voltage level and a second power domain with a second voltage level less than the first voltage level. V_{CCHG} may represent the first voltage level of the first power domain of the integrated circuit 100. A digital supply voltage (V_{CCL}) may represent the second voltage level of the second power domain of the integrated circuit 100. As described below with reference to FIGS. 6A-6C, V_{CCHG} and V_{CCL} may both be provided to the digital circuitry 110.

The power management circuitry 120 may include voltage reference circuitry 130 and a voltage regulator 140 (e.g., a low-dropout (LDO) regulator). The voltage reference circuitry 130 may be configured to provide a reference voltage (V_{REF}) to the voltage regulator 140. The voltage regulator 140 may be configured to provide V_{CCHG} to the digital circuitry 110 based on V_{REF} provided by the voltage reference circuitry 130. For example, the voltage regulator 140 may be implemented using a unity-gain amplifier or LDO regulator to maintain V_{CCHG} provided to the digital circuitry 110 at a relatively consistent voltage level. In this example, V_{CCHG} provided by the voltage regulator 140 may track or follow V_{REF} provided by the voltage reference circuitry 130. When V_{CCHG} tracks V_{REF}, V_{CCHG} may inherit various characteristics of V_{REF} such as the thermal response behavior of V_{REF}.

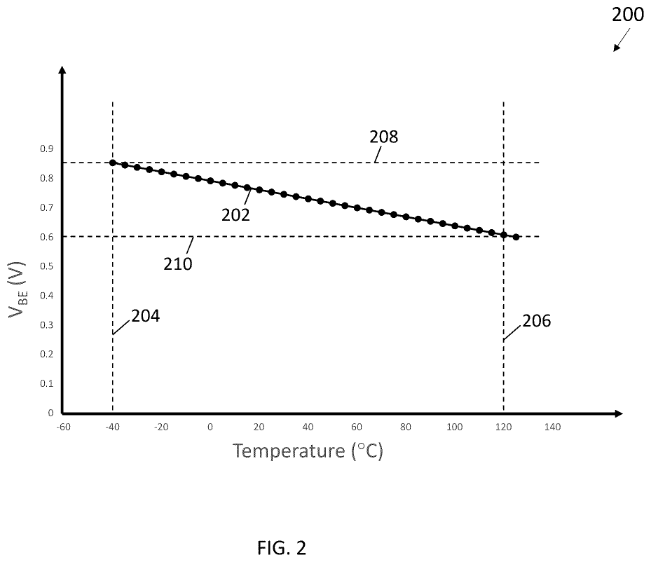

The voltage reference circuitry 130 may include a temperature dependent voltage source 150 configured to provide a voltage (VBE) that may exhibit a non-zero temperature gradient or coefficient. For example, VBE may vary as a function of temperature (e.g., an operating temperature of the power management circuitry 120 or an ambient temperature), as shown by diagram 200 of FIG. 2. The diagram 200 includes an example waveform 202 that represents VBE provided by the temperature dependent voltage source 150, as a function of temperature. The diagram 200 shows that an inverse relationship may exist between a voltage level of VBE provided by the temperature dependent voltage source 150 and an operating temperature of the power management circuitry 120 or an ambient temperature. For example, the operating temperature of the power management circuitry 120 may increase from a first temperature 204 (e.g., −40 degrees Celsius (° C.)) to a second temperature 206 (e.g., 120° C.) greater than the first temperature 204. Responsive to that increase in the operating temperature of the power management circuitry 120, VBE provided by the temperature dependent voltage source 150 may decrease from a first voltage level 208 (e.g., 0.85 volts (V)) to a second voltage level 210 (e.g., 0.6 V) less than the first voltage level 208.

In an embodiment, V_{BE} provided by the temperature dependent voltage source 150, as represented by the waveform 202, may be determined according to:

V_{BE}=−0.001535*T+0.7919 (1)

where T denotes the operating temperature of the power management circuitry 120 or ambient temperature in degrees Celsius. In accordance with equation (1), V_{BE} may have a temperature gradient or coefficient of −1.535 millivolts (mV)/° C. and a voltage level of 0.7919 V when the operating temperature of the power management circuitry 120 or ambient temperature is about 0° C. A voltage level (e.g., 0.7919 V) of V_{BE} when the operating temperature of the power management circuitry 120 or ambient temperature is about 0° C. may represent a constant portion of V_{BE} that may be independent of temperature. The non-zero temperature gradient (e.g., −1.535 mV/° C.) of V_{BE} provided by the temperature dependent voltage source 150 may be intrinsic to properties of one or more devices (e.g., a bipolar junction transistor) that comprise the temperature dependent voltage source 150.

In the various embodiments of the present disclosure, the temperature dependent voltage source 150 may represent a complementary to absolute temperature (CTAT) voltage source because of the inverse relationship shown by the diagram 200. In other embodiments, a direct relationship may exist between the operating temperature of the power management circuitry 120 and the voltage level of V_{BE} provided by the temperature dependent voltage source 150. For example, the voltage level of the non-zero temperature gradient of V_{BE} provided by the temperature dependent voltage source 150 may increase responsive to the operating temperature increasing and decrease responsive to the operating temperature decreasing. In such embodiments, the temperature dependent voltage source 150 may represent a proportional to absolute temperature (PTAT) voltage source because of that direct relationship.

With reference to FIG. 1, the voltage reference circuitry 130 may also include a divider circuit 160 to provide V_{REF} at a relatively consistent voltage level over a full temperature range (e.g., −40° C.-125° C.) by controlling the non-zero temperature gradient of V_{BE}. To that end, the temperature dependent voltage source 150 may provide V_{BE} to the divider circuit 160 having a first temperature gradient (e.g., the non-zero temperature gradient). The divider circuit 160 may be configured to provide a voltage (V_{DIV}) based on V_{BE}. V_{DIV} provided by the divider circuit 160 may have a second temperature gradient different than the first temperature gradient of V_{BE} provided by the temperature dependent voltage source 150. A difference between the first temperature gradient of V_{BE} and the second temperature gradient of V_{DIV} may be a gradient tuning parameter (M) implemented by the divider circuit 160 that changes the gradient by dividing by M. In an embodiment, V_{DIV} provided by the divider circuit 160 may be determined according to:

$${V}_{DIV} = \frac{{V}_{BE}}{M} \qquad ( 2 )$$

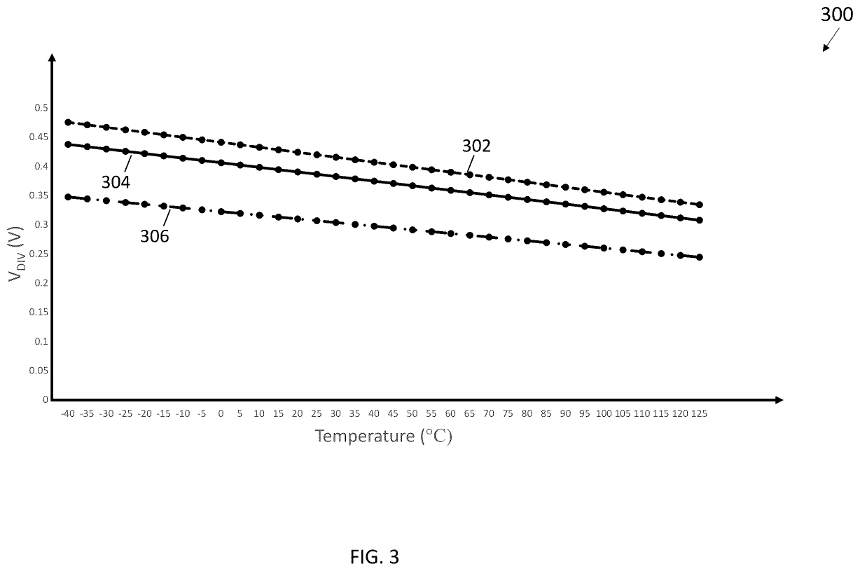

The difference between the first temperature gradient of V_{BE} and the second temperature gradient of V_{DIV} may be adjusted independent from temperature by adjusting a value of the gradient tuning parameter M. For example, FIG. 3 is a diagram 300 of example waveforms showing variations in a temperature gradient of V_{DIV} provided by configuring the gradient tuning parameter M of the divider circuit 160 with different values. The diagram 300 includes waveforms 302, 304, and 306 that may represent V_{DIV} provided by configuring the gradient tuning parameter M of the divider circuit 160 with values of 1.8, 1.95, and 2.5, respectively. In FIG. 3, each instance of V_{DIV} may be provided by the divider circuit 160 based on the same V_{BE} (e.g., V_{BE} represented by the waveform 202 of FIG. 2).

The diagram 300 shows that a value of the gradient tuning parameter M may control a temperature gradient of Vpiv provided by the divider circuit 160. For example, the waveform 302 representing V_{DIV} provided by configuring the gradient tuning parameter M of the divider circuit 160 with a value of 1.8 may have a first temperature gradient (e.g., about

$$\frac{- 1.535 mV / ° C .}{1.8}$$

or −0.85 mV/° C.). The waveform 304 representing V_{DIV} provided by configuring the gradient tuning parameter M of the divider circuit 160 with a value of 1.9 may have a second temperature gradient (e.g., about

$$\frac{- 1.535 mV / ° C .}{1.9}$$

or −0.79 mV/° C.) lower than the first temperature gradient. The waveform 306 representing V_{DIV} provided by configuring the gradient tuning parameter M of the divider circuit 160 with a value of 2.5 may have a third temperature gradient (e.g., about

$$\frac{- 1.535 mV / ° C .}{2.5}$$

or −0.61 mV/° C.) lower than the first temperature gradient and the second temperature gradient.

In FIG. 3, the temperature gradient of VDiv provided by the divider circuit 160 decreases from about −0.85 mV/° C. to about −0.61 mV/° C., as the value of the gradient tuning parameter M increases from 1.8 to 2.5. Each instance of V_{DIV} shown by FIG. 3 has a temperature gradient that is lower than the temperature gradient (e.g., about −0.1535 mV/° C.) of V_{BE} shown by FIG. 2. Generally, a value of the gradient tuning parameter M may be applied by the divider circuit 160 to a temperature gradient of V_{BE} to adjust a value of the temperature gradient of V_{BE} to any other value to set a value of the temperature gradient of V_{DIV}, as a matter of design choice.

In addition to being applied to the temperature gradient of V_{BE}, a value of the gradient tuning parameter M may also be applied by the divider circuit 160 to a constant portion of V_{BE} that represents a voltage level (e.g., 0.7919 V) of V_{BE} when the operating temperature of the power management circuitry 120 or ambient temperature is about 0° C. A value of the gradient tuning parameter M that the divider circuit 160 applies to a temperature gradient of V_{BE} to decrease a temperature gradient of V_{DIV} may also be applied to a constant portion of V_{BE} to generally decrease a voltage level of V_{DIV}. In an embodiment, V_{DIV} provided by the divider circuit 160 based on V_{BE} determined in accordance with equation (1), may be determined according to:

$${V}_{DIV} = \frac{- 0.001535 * T}{M} + \frac{0.7919}{M} \qquad ( 3 )$$

A voltage level of each instance of V_{DIV} shown by FIG. 3 at a given temperature is generally lower than a corresponding voltage level of V_{BE} shown by FIG. 2 at the given temperature. For example, the waveform 302 representing V_{DIV} provided by configuring the gradient tuning parameter M of the divider circuit 160 with a value of 1.8 may have voltage levels of about 0.475 V and 0.325 V when the operating temperature of the power management circuitry 120 or ambient temperature is about −40° C. and 125° C., respectively. The waveform 202 of FIG. 2 that represents V_{BE} provided by the temperature dependent voltage source 150 may have voltage levels of about 0.85 V and 0.6 V when the operating temperature of the power management circuitry 120 or ambient temperature is about −40° C. and 125° C., respectively. In some instances, controlling a value of the gradient tuning parameter M to decrease a temperature gradient of V_{DIV} may also decrease V_{DIV} to a voltage level that is below a designed or usable operating voltage range for the digital circuitry 110.

With reference to FIG. 1, the voltage reference circuitry 130 may be configured to provide a voltage (V_{REF})that remains within a designed or usable operating voltage range of the digital circuitry 110 over a full temperature range at a relatively consistent voltage level that remains within a designed or usable voltage range of the digital circuitry 110 over a full operating temperature range (e.g., −40° C.-125° C.) of the digital circuitry 110. To that end, the divider 160 may provide V_{DIV} to the adder circuit 170 having a first voltage level. The adder circuit 170 may be configured to provide V_{REF} based on V_{DIV}. V_{REF} provided by the adder circuit 170 may have a second voltage level greater than the first voltage level of V_{DIV} provided by the divider circuit 160. A difference between the first voltage level of V_{DIV} and the second voltage level of V_{REF} may be a level shift voltage (V_{FIX}) that the adder circuit 170 applies to V_{DIV}. In an embodiment, V_{REF} provided by the adder circuit 170 may be determined according to:

$${V}_{REF} = {V}_{DIV} + {V}_{FIX} = \frac{{V}_{BE}}{M} + {V}_{FIX} \qquad ( 4 )$$

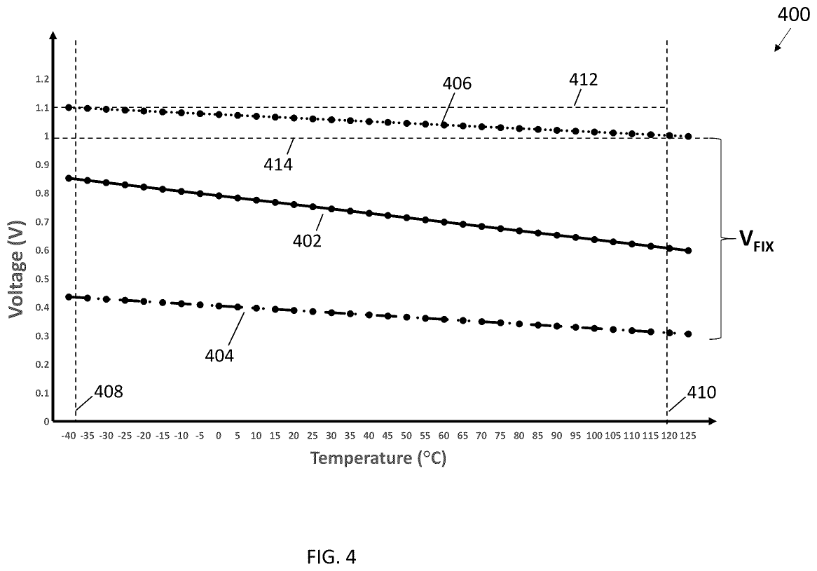

The first voltage level of V_{DIV} provided by the divider circuit 160 may be below or otherwise external to a designed or usable operating voltage range for the digital circuitry 110 over a full operating temperature range (e.g., −35° C.-120° C.) of the digital circuitry 110. The second voltage level of V_{REF} that the adder circuit 170 provides by applying V_{FIX} to V_{DIV} may be within the designed or usable operating voltage range for the digital circuitry 110 over the full operating temperature range, as shown by diagram 400 of FIG. 4. In other words, the division in the divider circuit 160 may cause the V_{REF} to be at a level unusable unless some voltage is added back by applying V_{FIX}.

The diagram 400 includes example waveforms 402, 404, and 406 that represent V_{BE} provided by the temperature dependent voltage source 150, V_{DIV} provided by the divider circuit 160, and V_{REF} provided by the adder circuit 170, respectively, as a function of temperature. The diagram 400 also includes a temperature 408 and a temperature 410 that may correspond to a lower bound temperature and an upper bound temperature, respectively, of a full operating temperature range of the digital circuitry 110. The diagram 400 also includes a voltage level 412 and a voltage level 414 that may correspond to an upper bound voltage and a lower bound voltage, respectively, of a designed or usable operating voltage range for the digital circuitry 110.

A comparison between the waveform 402 representing V_{BE} and the waveform 404 representing V_{DIV} shows that a voltage level of V_{DIV} remains more consistent than a voltage level of V_{BE} over the full operating temperature range of the digital circuitry 110 due to the flattening of the slope of the waveform 402 by dividing by M in the divider circuit 160. For example, the waveform 402 representing V_{BE} transitions from about 0.85 V at the temperature 408 to about 0.61 V at the temperature 410 for a temperature gradient of about 0.24 V (e.g., 0.85 V−0.61 V) over the full operating temperature range of the digital circuitry 110. The waveform 404 representing V_{DIV} transitions from about 0.44 V at the temperature 408 to about 0.32 V at the temperature 410 for a temperature gradient of about 0.12 V (e.g., 0.44 V−0.32 V) over the full operating temperature range of the digital circuitry 110.

The waveform 404 representing V_{DIV} shows that while remaining more consistent than the voltage level of V_{BE} over the full operating temperature range of the digital circuitry 110, the voltage level of V_{DIV} may remain external to the designed or usable operating voltage range for the digital circuitry 110. For example, the waveform 404 representing V_{DIV} remains below the voltage level 414 at both the temperature 408 and the temperature 410. A comparison between the waveform 404 representing V_{DIV} and the waveform 406 representing V_{REF} shows that in contrast to V_{DIV} a voltage level of V_{REF} remains within the designed or usable operating voltage range for the digital circuitry 110 over the full operating temperature range of the digital circuitry 110. For example, the waveform 406 representing V_{REF} is at or below the voltage level 412 at the temperature 408. As another example, the waveform 406 representing V_{REF} is at or above the voltage level 414 at the temperature 410.

A comparison between the waveform 402 representing V_{BE} and the waveform 406 representing V_{REF} shows that, similar to V_{DIV}, a voltage level of V_{REF} remains more consistent than the voltage level of V_{BE} over the full operating temperature range of the digital circuitry 110. For example, the waveform 402 representing V_{BE} has a temperature gradient of about 0.24 V (e.g., 0.85 V−0.61 V) over the full operating temperature range of the digital circuitry 110, as described above. The waveform representing V_{REF} transitions from about 1.1 V at the temperature 408 to about 1.0 V at the temperature 410 for a temperature gradient of about 0.1 V (e.g., 1.1 V−1.0 V) over the full operating temperature range of the digital circuitry 110.

As described above, V_{CCHG} provided by the voltage regulator 140 may track or follow V_{REF} provided by the voltage reference circuitry 130. When V_{CCHG} tracks V_{REF}, maintaining a voltage level of V_{REF} within a designed or usable operating voltage range of the digital circuitry 110 over a full operating temperature range of the digital circuitry 110 using the gradient tuning parameter M and/or V_{FIX} may also maintain a voltage level of V_{CCHG} within the designed or usable operating voltage range over the full operating temperature range.

In an embodiment, V_{FIX} may be a fixed voltage level or a voltage level that remains constant or substantially constant over a full operating temperature range of the digital circuitry 110 (e.g., −40° C.-125° C.). In an embodiment, V_{FIX} may be a trimmable (e.g., variable) voltage level or a plurality of voltage levels over a full operating temperature range of the digital circuitry 110. For example, a voltage level of V_{FIX} may vary as a function of temperature (e.g., an operating temperature of the power management circuitry 120 or an ambient temperature) such that a voltage level of V_{FIX} increases as temperature increases and/or a value of V_{FIX} decreases as temperature decreases.

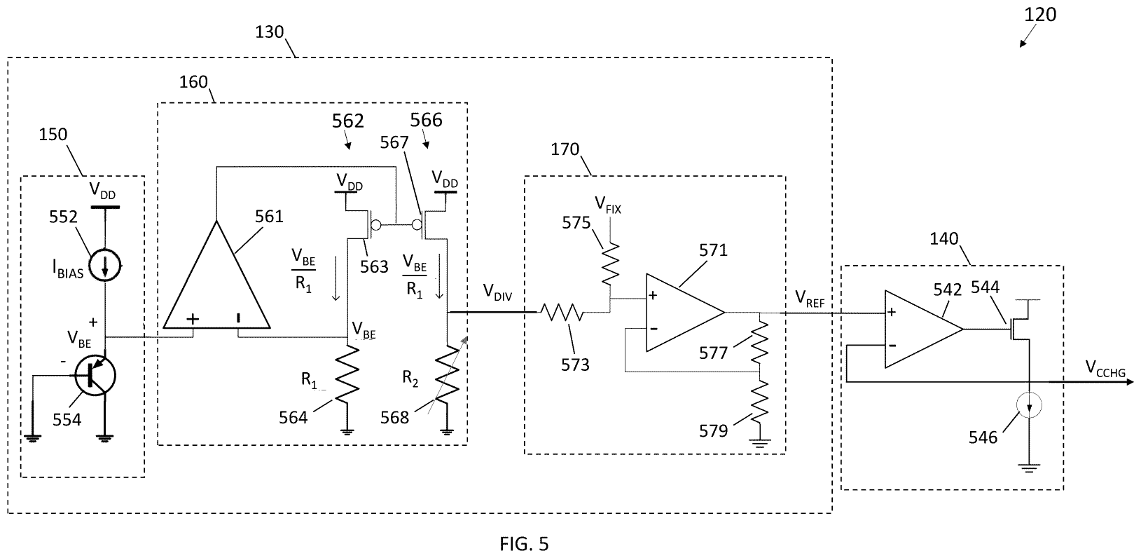

FIG. 5 is a schematic diagram of an example implementation of the power management circuitry 120, in accordance with aspects of the present disclosure. The voltage regulator 140 may include an amplifier 542, a transistor 544 (e.g., an n-channel field-effect transistor (FET)), and a current sink 546. The temperature dependent voltage source 150 may include a current source 552 and a bipolar transistor 554 (e.g., a PNP bipolar junction transistor). The divider circuit 160 may include an amplifier 561, a first leg formed 562 by a transistor 563 (e.g., a p-channel FET) and a resistor 564, and a second leg 566 formed by a transistor 567 (e.g., a p-channel FET) and a resistor 568. The adder circuit 170 may include an amplifier 571, a resistor 573, a resistor 575, a resistor 577, and a resistor 579.

In an example architecture of the power management circuitry 120, a first terminal of the current source 552 may be coupled to receive a supply voltage (V_{DD}). A base and a collector of the bipolar transistor 554 may be coupled to a ground node. An emitter of the bipolar transistor 554 may be coupled to a second terminal of the current source 552 and to a first input (e.g., a non-inverting or positive input) of the amplifier 561. A second input (e.g., an inverting or negative input) of the amplifier 561 may be coupled to a first terminal of the resistor 564 and to a drain of the transistor 563. An output of the amplifier 561 may be coupled to a gate of the transistor 563 and to a gate of the transistor 567. A source of the transistor 563 and a source of the transistor 567 may be coupled to V_{DD}. A drain of the transistor 567 may be coupled to a first terminal of the resistor 568 and to a first terminal of the resistor 573. A second terminal of the resistor 564 and a second terminal of the resistor 568 may be coupled to the ground node.

A second terminal of the resistor 573 may be coupled to a first input (e.g., a non-inverting or positive input) of the amplifier 571 and to a first terminal of the resistor 575. A second terminal of the resistor 575 may be coupled to receive V_{FIX}. In an embodiment, V_{FIX} may be an internal voltage generated within the power management circuitry 120. In an embodiment, V_{FIX} may be an external voltage generated external to the power management circuitry 120. A second input (e.g., an inverting or negative input) of the amplifier 571 may be coupled to a first terminal of the resistor 577 and to a first terminal of the resistor 579. A second terminal of the resistor 577 may be coupled to an output of the amplifier 571 and to a first input (e.g., a non-inverting or positive input) of the amplifier 542. A second terminal of the resistor 579 may be coupled to the ground node. A second input (e.g., an inverting or negative input) of the amplifier 542 may be coupled to a first terminal of the current sink 546 and to a source of the transistor 544. A gate and a drain of the transistor 544 may be coupled to an output of the amplifier 542 and to V_{DD}, respectively. A second terminal of the current sink 546 may be coupled to the ground node.

In operation, the emitter of the bipolar transistor 554 may provide V_{BE} at the first amplifier input (e.g., non-inverting or positive input) of the amplifier 561 based on a current (I_{BIAS}) provided by the current source 552. In an embodiment, I_{BIAS} provided by the current source 552 may be about 10 microamp (μA). As described above, the temperature dependent voltage source 150 may be a CTAT voltage source and V_{BE} may vary as a function of temperature. The amplifier 561 may be configured to provide V_{BE} at the first terminal of the resistor 564 based on V_{BE} provided at the first amplifier input of the amplifier 561. For example, the amplifier 561 implemented as a unity-gain amplifier.

A current may flow through the first leg 562 of the divider circuit 160 based on the amplifier 561 provided V_{BE} at the first terminal of the resistor 564. The current flowing through the first leg 562 of the divider circuit 160 may be determined according to V_{BE}/R₁, where R₁ denotes a resistance value of the resistor 564. A gate-to-source voltage (V_{GS}) of the transistor 563 may be equal to or substantially equal to V_{GS} of the transistor 567. The current flowing through the first leg 562 of the divider circuit 160 may be replicated in the second leg 566 of the divider circuit 160 when V_{GS} of the transistor 563 is equal to or substantially equal to V_{GS} of the transistor 567. A current flowing through the second leg 566 of the divider circuit 160 when V_{GS} of the transistor 563 is equal to or substantially equal to V_{GS} of the transistor 567 may also be determined according to V_{BE}/R₁, where R₁ denotes a resistance value of the resistor 564.

V_{DIV} is provided at the first terminal of the resistor 573 when the current flowing through the first leg 562 is replicated in the second leg 566 may be determined according to V_{BE}* (R₁/R₂) or V_{BE}/M, where R₂ denotes a resistance value of the resistor 568 and M is the gradient tuning parameter that may be determined according to (R₁/R₂). A value of the gradient tuning parameter M may be adjusted by changing one or more of R₁ and R₂. For example, the value of the gradient tuning parameter M may be increased by increasing R₂ or decreased by decreasing R₂. As another example, the value of the gradient tuning parameter M may be decreased by increasing R₁ or increased by decreasing R₁. As such, to provide programmability for M, at least one of the resistors 654 and/or 568 may be a variable resistor. For instance, the resistor 568 is show as a variable resistor, but additionally or alternatively, the resistor 564 may be a variable resistor to enable a change in the ratio of R₁/R₂. As described above, a voltage level of V_{DIV} may remain external to a designed or usable operating voltage range of the digital circuitry 110 by operation of the divider circuitry 160.

V_{FIX} and V_{DIV} may be provided at the first amplifier input (e.g., the non-inverting or positive) of the amplifier 571 via the resistor 575 and the resistor 573, respectively. As described above, V_{FIX} may be a level shift voltage that the adder circuit 170 applies to V_{DIV} to provide V_{REF} to the voltage regulator 140 at a voltage level that is within a designed or usable operating voltage range of the digital circuitry 110. The amplifier 571 may be configured to provide V_{REF} at the first amplifier input (e.g., the non-inverting or positive) of the amplifier 542 based on V_{FIX} and V_{DIV} that are provided at the first amplifier input (e.g., the non-inverting or positive) of the amplifier 571. In an embodiment, a resistance value of the resistor 577 and/or a resistance value of the resistor 579 may configure the amplifier 571 to operate as a unity-gain amplifier. The amplifier 542 may be configured to provide V_{CCHG} at the source of the transistor 544 based on V_{REF} provided at the at the first amplifier input (e.g., the non-inverting or positive) of the amplifier 542. To that end, the amplifier 542 may be configured to operate as a common source amplifier by providing a signal to a gate of the transistor 544 to cause the transistor 544 to provide a current to the current sink 546.

In an embodiment, V_{FIX} may be a fixed voltage level that the adder circuit 170 applies to V_{DIV}. In an embodiment, V_{FIX} may be a trimmable voltage level that the adder circuit 170 applies to V_{DIV}. A trimmable voltage level of V_{FIX} may be determined based on one or more of an upper bound voltage of the designed or usable operating voltage range of the digital circuitry 110, a lower bound voltage of the designed or usable operating voltage range of the digital circuitry 110, and a temperature gradient of V_{DIV}. In an embodiment, the upper bound voltage of the designed or usable operating voltage range of the digital circuitry 110 may be a voltage level at a lower bound temperature of a full operating temperature range of the digital circuitry 110. In an embodiment, the lower bound voltage of the designed or usable operating voltage range of the digital circuitry 110 may be a voltage level at an upper bound temperature of the full operating temperature range of the digital circuitry 110.

FIGS. 6A-6C are schematic diagrams of example implementations of the digital circuitry 110 of FIG. 1, in accordance with aspects of the present disclosure. FIG. 6A shows that the digital circuitry 110 may implement logic driver circuitry with a transistor 602 (e.g., a p-channel FET) and a transistor 604 (e.g., a n-channel FET). In an example architecture of the digital circuitry 110, a source of the transistor 602 may be coupled to receive V_{CCHG} from the power management circuitry 120. A gate of the transistor 602 may be coupled to a gate of the transistor 604. The gate of the transistor 602 may also be coupled to preceding digital circuitry 606 such as one or more preceding inverter driver(s), one or more preceding logic gate circuit(s) (e.g., XOR logic gate(s), XNOR logic gate(s), AND logic gate(s), NAND logic gate(s), OR logic gate(s), NOR logic gate(s), and/or other logic gate(s)), and/or other preceding digital circuitry. A drain of the transistor 602 may be coupled to a drain of the transistor 604. A source of the transistor 604 may be coupled to a ground node. Operating speed of the logic driver circuitry implemented by the transistor 602 and the transistor 604 may operate faster when the power management circuitry 120 increases a voltage level of V_{CCHG} provided at the source of the transistor 602. For example, increasing a voltage level of V_{CCHG} provided at the source of the transistor 602 may decrease an average propagation delay by the transistor 602 and the transistor 604.

FIG. 6B shows that the digital circuitry 110 may implement logic driver circuitry with a transistor 611 and a transistor 612 (e.g., a p-channel FET) and a transistor 613 (e.g., a n-channel FET). A body of the transistor 611 may be coupled to receive V_{CCHG} from the power management circuit 120. A source of the transistor 611 may be coupled to receive V_{CCL}. A gate of the transistor 611 may be coupled to a gate of the transistor 613. The gate of the transistor 611 may also be coupled to preceding digital circuitry 619 such as one or more preceding inverter driver(s), one or more preceding logic gate circuit(s) (e.g., XOR logic gate(s), XNOR logic gate(s), AND logic gate(s), NAND logic gate(s), OR logic gate(s), NOR logic gate(s), and/or other logic gate(s)), and/or other preceding digital circuitry. A drain of the transistor 611 may be coupled to a drain of the transistor 613. A diode 615 may be coupled between the body and the source of the transistor 611. A diode 617 may be coupled between the body and the drain of the transistor 611. In an embodiment, the diode 615 and/or the diode 617 may be a parasitic device that may be intrinsic to a structure of the transistor 611. A source of the transistor 613 may be coupled to a ground node. V_{CCHG} may be provided to the body of the transistor 611 to reduce leakage current flow through the diode 615 as a voltage (V_{BS}) between the body and the source of the transistor 611. V_{BS} may increase when a voltage difference between V_{CCHG} and V_{CCL} increases.

FIG. 6C shows that the digital circuitry 110 may implement pass transistor logic of the integrated circuit 100 with a transistor 622 (e.g., a n-channel FET) and a capacitance 624. In an example architecture of the digital circuitry 110, a source and a gate of the transistor 622 may be coupled to receive V_{CCL} and V_{CCHG}, respectively. A drain of the transistor 622 may be coupled to a first side of the capacitance 624. A second side of the capacitance 624 may be coupled to a ground node. In an embodiment, the capacitance 624 may be a parasitic capacitance that may be associated with the drain of the transistor 622. In an embodiment, a routing fabric of the integrated circuit 100 may include the transistor 622. For example, the transistor 622 may be configured as a pass transistor or multiplexer in the routing fabric of the integrated circuit 100. In operation, signals in a power domain of the integrated circuit 100 associated with V_{CCL} may be transferred between the source and the drain the transistor 622 based on V_{CCHG} provided at the gate of the transistor 622.

For a given voltage level of V_{CCHG} provided at the gate of the transistor 622, a total gate oxide (GOX) defects per million (DPM) may rise as temperature increases. A voltage level of V_{CCHG} provided at the gate of the transistor 622 may be decreased (e.g., about 1.02 V or less) at higher temperatures (e.g., about 100° C.or higher) to improve DPM. Conversely, a voltage level of V_{CCHG} provided at the gate of the transistor 622 may be increased (e.g., at least 1.11 V) at lower temperatures, which increases gate drive that V_{CCHG} provides to the transistor 622. At lower temperatures (e.g., about −10° C. or less), a voltage level of V_{CCHG} provided at the gate of the transistor 622 may be increased to maintain sufficient gate drive for the transistor 622.

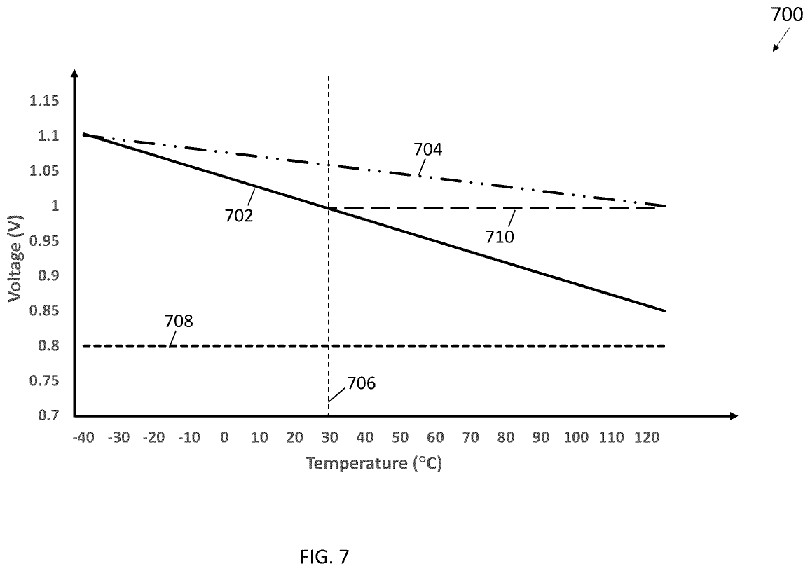

FIG. 7 is a diagram 700 of example waveforms that show a comparison between V_{CCGH} provided to the digital circuitry 110 by the power management circuitry 120 that includes the divider circuit 160 and the adder circuit 170 and by power management circuitry that does not include the divider circuit 160 and the adder circuit 170. The diagram 700 includes waveform 702 that represents V_{CCHG} provided to the digital circuitry 110 by the power management circuitry that does not include the divider circuit 160 and the adder circuit 170. The diagram 700 also includes waveform 704 that represents V_{CCHG} provided to the digital circuitry 110 by the power management circuitry 120 that includes the divider circuit 160 and the adder circuit 170. Waveform 708 of the diagram 700 may represent Vcci provided to the digital circuitry 110.

In the diagram 700, V_{CCHG} and V_{CCL} may be provided to a logic driver implementation of the digital circuitry 110, such as the logic driver implementation shown by FIG. 6A. The logic driver implementation of the digital circuitry 110 may need V_{CCHG} to remain at least 0.2 volts higher than V_{CCL} to properly operate. Waveform 702 that represents V_{CCHG} provided by the power management circuitry that does not include the divider circuit 160 and the adder circuit 170 may be clipped at a temperature 706 (e.g., about 30° C.) to remain at least 0.2 volts higher than V_{CCL}. For example, the waveform 702 that represents V_{CCHG} provided by the power management circuitry that does not include the divider circuit 160 and the adder circuit 170 may be clipped to a voltage level 710 (e.g., about 1 V) at the temperature 708. In contrast, the waveform 704 that represents V_{CCHG} provided by the power management circuitry 120 that includes the divider circuit 160 and the adder circuit 170 remains at least 0.2 volts higher than Vcci without being clipped, as shown by the diagram 700. For example, the waveform 704 that represents V_{CCHG} provided by the power management circuitry 120 that includes the divider circuit 160 and the adder circuit 170 may have a voltage level of about 1.06 V at the temperature 708.

Example performance metrics obtained by providing V_{CCHG} represented by the waveform 702 and V_{CCHG} represented by the waveform 704 to the logic driver implementation of the digital circuitry 110 at about 30° C.(e.g., the temperature 708) are shown below in Table 1. The logic driver implementation of the digital circuitry 110 may be configured to operate as an inverter to obtain the example performance metrics shown by Table 1. In Table 1, V_{CCHG} (e.g., the waveform 702) provided by the power management circuitry that does not include the divider circuit 160 and the adder circuit 170 may be clipped to about 1.0 V (the voltage level 710) at a temperature of about 30° C. (e.g., the temperature 708).

Table 1 generally shows propagation delays of the logic driver implementation of the digital circuitry 110 may be lower when the power management circuitry 120 that includes the divider circuit 160 and the adder circuit 170 provides V_{CCHG} than when the power management circuitry that does not include the divider circuit 160 and the adder circuit 170 provides V_{CCHG}. For example, an average propagation delay of the logic driver implementation of the digital circuitry 110 when the power management circuitry that does not include the divider circuit 160 and the adder circuit 170 provides V_{CCHG} (e.g., the waveform 702 clipped to the voltage level 710) may be about 6.165 picoseconds (ps). In contrast, an average propagation delay of the logic driver implementation of the digital circuitry 110 when the power management circuitry 120 that includes the divider circuit 160 and the adder circuit 170 provides V_{CCHG} (e.g., the waveform 702 of FIG. 7) may be about 5.19 ps or about 16 percent less than 6.165 ps.

TABLE 1

| | VCCHG 1 V | VCCHG 1.06 V |
|---|---|---|
| | @ 30° C. (ps) | @ 30° C. (ps) |
| Input Rise to | 4.71 | 3.7 |
| Output Fall Delay | | |
| Input Fall to Output | 7.62 | 6.68 |
| Rise Delay | | |
| Average Delay | 6.165 | 5.19 |

Similar performance enhancements may be obtained when the power management circuitry 120 that includes the divider circuit 160 and the adder circuit 170 provides V_{CCHG} to other implementations of the digital circuitry 110 such as the pass transistor logic implementation shown by FIG. 6C. For example, a peak charging current of about 62 μA may flow from the source to the drain of the transistor 622 when the power management circuitry that does not include the divider circuit 160 and the adder circuit 170 provides V_{CCHG} to the gate of the transistor 622 at about 30° C. In contrast, a peak charging current of about 90 μA (e.g., about 1.45 times more than 62 μA) may flow from the source to the drain of the transistor 622 when the power management circuitry 120 that includes the divider circuit 160 and the adder circuit 170 provides V_{CCHG} to the gate of the transistor 622 at about 30° C.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. An integrated circuit comprising a voltage regulator and voltage reference circuitry. The voltage reference circuitry includes a temperature dependent voltage source, a divider circuit, and an adder circuit. The divider circuit is coupled to the voltage regulator by the adder circuit. The divider circuit is coupled between the temperature dependent voltage source and the adder circuit.

EXAMPLE EMBODIMENT 2. The integrated circuit of example embodiment 1, comprising digital circuitry coupled to the voltage reference circuitry by the voltage regulator.

EXAMPLE EMBODIMENT 3. The integrated circuit of example embodiment 1, wherein the divider circuit includes a first leg with a first transistor and a second leg with a second transistor coupled in parallel with the first transistor.

EXAMPLE EMBODIMENT 4. The integrated circuit of example embodiment 3, wherein a gate-to-source voltage of the first transistor is equal to a gate-to-source voltage of the second transistor.

EXAMPLE EMBODIMENT 5. The integrated circuit of example embodiment 3, wherein the divider circuit includes an amplifier with an output coupled to a gate of the first transistor and to a gate of the second transistor.

EXAMPLE EMBODIMENT 6. The integrated circuit of example embodiment 3, wherein one or more of the first transistor and the second transistor are coupled to a ground node by a variable resistance.

EXAMPLE EMBODIMENT 7. The integrated circuit of example embodiment 1, wherein the adder circuit includes an amplifier with an amplifier input coupled to the divider circuit by a first resistance and to a level shift voltage by a second resistance.

EXAMPLE EMBODIMENT 8. The integrated circuit of example embodiment 1, wherein the adder circuit includes an amplifier with an amplifier input coupled to a ground node by a first resistance and to the voltage regulator by a second resistance.

EXAMPLE EMBODIMENT 9. An integrated circuit comprising a temperature dependent voltage source configured to provide a first voltage; a divider circuit coupled to the temperature dependent voltage source and configured to flatten a temperature gradient curve by providing a second voltage based on the first voltage; and a voltage regulator coupled to temperature dependent voltage source by the divider circuit, the voltage regulator configured to provide a third voltage to digital circuitry of the integrated circuit based on the second voltage.

EXAMPLE EMBODIMENT 10. The integrated circuit of example embodiment 9, wherein the divider circuit is configured to provide the second voltage by applying a gradient tuning parameter to the first voltage to change a temperature gradient of the first voltage.

EXAMPLE EMBODIMENT 11. The integrated circuit of example embodiment 9, wherein a gradient tuning parameter of the divider circuit tunes a slope of a temperature gradient of the second voltage.

EXAMPLE EMBODIMENT 12. The integrated circuit of example embodiment 9, wherein the divider circuit includes a first leg with a first resistance and a second leg with a second resistance, and a gradient tuning parameter of the divider circuit is determined by one or more of a resistance value of the first resistance and a resistance value of the second resistance.

EXAMPLE EMBODIMENT 13. The integrated circuit of example embodiment 9, wherein the divider circuit includes a gradient tuning parameter, and an inverse relationship exists between a value of the gradient tuning parameter and a temperature gradient of the second voltage.

EXAMPLE EMBODIMENT 14. The integrated circuit of example embodiment 9, wherein in a voltage level of the second voltage is less than a voltage level of the first voltage.

EXAMPLE EMBODIMENT 15. The integrated circuit of example embodiment 9, comprising an adder circuit configured to provide a fourth voltage based on the second voltage, and the voltage regulator configured to provide the third voltage based on the fourth voltage.

EXAMPLE EMBODIMENT 16. The integrated circuit of example embodiment 15, the adder circuit comprising an amplifier with an amplifier input coupled to the divider circuit by a first resistance and to a level shift voltage by a second resistance.

EXAMPLE EMBODIMENT 17. The integrated circuit of example embodiment 16, wherein a difference between a voltage level of the second voltage and a voltage level of the fourth voltage is the level shift voltage.

EXAMPLE EMBODIMENT 18. An integrated circuit comprising digital circuitry and voltage reference circuitry coupled to the digital circuitry by a voltage regulator. The voltage reference circuitry including a temperature dependent voltage source, a divider circuit, and an adder circuit. The adder circuit coupled to the temperature dependent voltage source by the divider circuit.

EXAMPLE EMBODIMENT 19. The integrated circuit of example embodiment 18, the divider circuit configured to provide a first voltage based on a second voltage provided by the temperature dependent voltage source and a gradient tuning parameter with a value that is determined by a ratio of resistance values of resistors in the divider circuit.

EXAMPLE EMBODIMENT 20. The integrated circuit of example embodiment 18, the adder circuit configured to provide a fourth voltage based on a first voltage provided by the divider circuit and a level shift voltage that has a voltage level determined by one or more of a designed operating voltage range of the digital circuitry and a temperature gradient of the first voltage.

What is claimed is:

1. An integrated circuit comprising:
a voltage regulator; and
voltage reference circuitry that includes a temperature dependent voltage source, a divider circuit, and an adder circuit, wherein the divider circuit is coupled to the voltage regulator by the adder circuit, and the divider circuit is coupled between the temperature dependent voltage source and the adder circuit.

2. The integrated circuit of claim 1, comprising digital circuitry coupled to the voltage reference circuitry by the voltage regulator.

3. The integrated circuit of claim 1, wherein the divider circuit includes a first leg with a first transistor and a second leg with a second transistor coupled in parallel with the first transistor.

4. The integrated circuit of claim 3, wherein a gate-to-source voltage of the first transistor is equal to a gate-to-source voltage of the second transistor.

5. The integrated circuit of claim 3, wherein the divider circuit includes an amplifier with an output coupled to a gate of the first transistor and to a gate of the second transistor.

6. The integrated circuit of claim 3, wherein one or more of the first transistor and the second transistor are coupled to a ground node by a variable resistance.

7. The integrated circuit of claim 1, wherein the adder circuit includes an amplifier with an amplifier input coupled to the divider circuit by a first resistance and to a level shift voltage by a second resistance.

8. The integrated circuit of claim 1, wherein the adder circuit includes an amplifier with an amplifier input coupled to a ground node by a first resistance and to the voltage regulator by a second resistance.

9. An integrated circuit comprising:
a temperature dependent voltage source configured to provide a first voltage [V_{BE}];
a divider circuit coupled to the temperature dependent voltage source and configured to flatten a temperature gradient curve by providing a second voltage [V_{DIV}] based on the first voltage [V_{BE}]; and
a voltage regulator coupled to temperature dependent voltage source by the divider circuit, the voltage regulator configured to provide a third voltage [V_{CCHG}] to digital circuitry of the integrated circuit based on the second voltage [V_{DIV}].

10. The integrated circuit of claim 9, wherein the divider circuit is configured to provide the second voltage [V_{DIV}] by applying a gradient tuning parameter to the first voltage [V_{BE}] to change a temperature gradient of the first voltage [V_{BE}].

11. The integrated circuit of claim 9, wherein a gradient tuning parameter of the divider circuit tunes a slope of a temperature gradient of the second voltage [V_{DIV}].

12. The integrated circuit of claim 9, wherein the divider circuit includes a first leg with a first resistance and a second leg with a second resistance, and a gradient tuning parameter of the divider circuit is determined by one or more of a resistance value of the first resistance and a resistance value of the second resistance.

13. The integrated circuit of claim 9, wherein the divider circuit includes a gradient tuning parameter, and an inverse relationship exists between a value of the gradient tuning parameter and a temperature gradient of the second voltage [V_{DIV}].

14. The integrated circuit of claim 9, wherein in a voltage level of the second voltage [V_{DIV}] is less than a voltage level of the first voltage [V_{BE}].

15. The integrated circuit of claim 9, comprising an adder circuit configured to provide a fourth voltage [V_{REF}] based on the second voltage [V_{DIV}], and the voltage regulator configured to provide the third voltage [V_{CCHG}] based on the fourth voltage [V_{REF}].

16. The integrated circuit of claim 15, the adder circuit comprising an amplifier with an amplifier input coupled to the divider circuit by a first resistance and to a level shift voltage [V_{FIX}] by a second resistance.

17. The integrated circuit of claim 16, wherein a difference between a voltage level of the second voltage [V_{DIV}] and a voltage level of the fourth voltage [V_{REF}] is the level shift voltage [V_{FIX}].

18. An integrated circuit comprising:
digital circuitry; and
voltage reference circuitry coupled to the digital circuitry by a voltage regulator, the voltage reference circuitry including a temperature dependent voltage source, a divider circuit, and an adder circuit, and the adder circuit coupled to the temperature dependent voltage source by the divider circuit.

19. The integrated circuit of claim 18, the divider circuit configured to provide a first voltage [V_{DIV}] based on a second voltage [V_{BE}] provided by the temperature dependent voltage source and a gradient tuning parameter with a value that is determined by a ratio of resistance values of resistors in the divider circuit.

20. The integrated circuit of claim 18, the adder circuit configured to provide a fourth voltage [V_{REF}] based on a first voltage [V_{DIV}] provided by the divider circuit and a level shift voltage [V_{FIX}] that has a voltage level determined by one or more of a designed operating voltage range of the digital circuitry and a temperature gradient of the first voltage.
